(19) United States
(12) Patent Application Publication
(10) Pub. No.: US 2008/0123554 A1
(43) Pub. Date: May 29, 2008

(54) DEPLOYING APPARATUS, METHOD, AND COMPUTER READABLE MEDIUM THEREOF FOR DEPLOYING A NETWORK IN A SPACE

(75) Inventors: Cheng-Hsien Ku, Yonghe City (TW); Hung-Ren Lai, Hualian City (TW)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(73) Assignee: INSTITUTE FOR INFORMATION INDUSTRY, Taipei (TW)

(21) Appl. No.: 11/679,778

(22) Filed: Feb. 27, 2007

(30) Foreign Application Priority Data
Nov. 24, 2006 (TW) 095143601

(51) Int. Cl. H04L 12/28

(52) U.S. Cl. 370/254

(57) ABSTRACT

A deploying apparatus, a method, and a computer readable medium thereof for deploying a network in a space are provided. The method generates a plurality of grid points in the space and then disposes a first network node having a first effective connection range on one of the grid points. After that the following rule can be repeated: if a new network node is required to be disposed, it has to be disposed on a grid point that covered by at least one of the effective connection ranges of the previous disposed network nodes. In addition, an effective connection range of the new network node has to cover one of the previous disposed network nodes. By using the technique, the network can be deployed rapidly without heavy calculation. Furthermore, when the setting of the space changes or when the number of the network nodes changes, the technique does not have to deploy the whole network in the space again. It only has to adjust the deployment of part of the network in the space.

This application claims the benefit of priority based on Taiwan Patent Application No. 095143601 filed on Nov. 24, 2006 of which the contents are incorporated herein by reference in its entirety.

### CROSS-REFERENCES TO RELATED APPLICATIONS

Not applicable.

### BACKGROUND OF THE INVENTION

1. Field of the Invention

The present invention relates to a deploying apparatus and a deploying method; more specifically, relates to a deploying apparatus and a deploying method for deploying a network in a space. The method can be implemented by a computer program which is stored in a computer readable medium.

2. Descriptions of the Related Art

Technologies of wireless network can be divided into wireless wide area network (WWAN), wireless metropolitan area network (WMAN), wireless local area network (WLAN), and wireless personal area network (WPAN) according to the corresponding communication distance. In addition to the aforementioned technologies of wireless network, wireless sensor network (WSN) is also highly emphasized in recent years.

Nowadays, the wireless sensor network is mainly applied to various sensing, state monitoring, and device controlling, such as temperature sensing, monitoring, and controlling of factory boilers, switching of rolling doors of shops, ambient light sensing of houses, illumination controlling, air conditioning, household appliance controlling, toy controlling, computer peripheral controlling, security sensing, and medical sensing, etc., with almost uncountable applicable ranges. In the past, the applications of sensing and monitoring utilize either physical wires for transmitting messages or infrared (IR) for controlling. Nowadays, the wireless sensor network is used for replacing the physical wires and the infrared to accomplish automatic applications in sensing, monitoring, and controlling in a more flexible and convenient way to even increase simplicity for integration and potential for variation.

While applying the wireless sensor network, many sensor nodes have to be disposed in a space to form an effective wireless network. However, how to deploy the wireless network accurately and completely, and dispose all the network nodes within an effective range of the wireless network to transmit data through the wireless network is a very important topic.

Techniques of deploying a wireless network in a space of the prior art can be divided to two types. The first type is to practically measure all available locations that can be disposed network nodes in the space to determine whether an effective range required by the wireless network can be achieved and to determine whether all the network nodes can transmit data. The second type is to simulate the effective range of the wireless network that is to be deployed by a simulation method. The second type of approaches first builds a model for the space and deploys the wireless network according to antenna signal radiation patterns of network nodes made by different manufacturers. After the aforementioned data have been collected, an optimum algorithm randomly and iteratively chooses a location for each of the network nodes to be disposed on. When the space is larger or an amount of the network nodes is large, data that have to be calculated by the optimizing algorithm increases as well, which results in a longer calculation time. Furthermore, this kind of one-time simulation method requires to re-calculate locations for all the network nodes once a size of the space is changed or the amount of the network nodes is changed. Thus, it is extremely inconvenient in practice.

Therefore, how to dispose network nodes in a space to successfully form a wireless network by an approach that data amount required to be calculated is reduced and a deploying time is shortened is very important. Furthermore, when the size of the space and/or the amount of the network nodes are/is changed, how to re-dispose only the network nodes within the changed portion is still an objective to endeavor.

### SUMMARY OF THE INVENTION

One objective of this invention is to provide a method for deploying a network in a space. The method comprises the following steps: generating a plurality of grid points in the space; disposing a first network nodes having a first effective connection range on one of the grid points, wherein the first effective connection range covers a part of the grid points; marking a part of the grid points covered by the first effective connection range as the first grid point; and disposing a second network node of the second effective connection range on one of the grid points, wherein the second effective connection range covers the first network node and a part of the grid points. An effective connection range of the network in the space covers the first effective connection range and the second effective connection range.

Another objective of this invention is to provide a method for deploying a network in a space. The network has a plurality of network nodes, and each of the network nodes has an effective connection range. The method comprises the following steps: generating a plurality of grid points in the space; marking the grid points covered by the effective connection ranges as the effective grid points; and disposing a first network node having a first effective connection range on one of the effective grid points, wherein the first effective connection range covers one of the network nodes and a part of the grid points. The effective connection range of the network in the space covers the first effective connection range and the effective connection ranges of the network nodes.

Yet another objective of this invention is to provide a deploying apparatus capable of deploying a network in a space. The deploying apparatus comprises a grid point generation module, a disposition module, and a marking module. The grid point generation module generates a plurality of grid points in the space. The disposition module disposes a first network node having a first effective connection range on one of the grid points, wherein the first effective connection range covers a part of the grid points. The marking module marks a part of the grid points covered by the first effective connection range as first grid points. The disposition module further disposes a second network node having a second effective connection range on one of the first grid points. The second effective connection range covers the first network node and a part of the grid points. An effective connection range of the network in the space covers the first effective connection range and the second effective connection range.

A further objective of this invention is to provide a deploying apparatus capable of deploying a network in a space. The network has a plurality of network nodes, and each of the network nodes has an effective connection range. The deploying apparatus comprises a grid point generation module, a marking module, and a disposition module. The grid point generation module generates a plurality of grid points in the space. The marking module marks the grid points covered by the effective connection ranges as effective grid points. The disposition module disposes a first network node having a first effective connection range on one of the effective grid points, wherein the first effective connection range covers one of the network nodes and a part of the grid points. The effective range of the network in the space covers the first effective connection range and the effective connection ranges of the network nodes.

Yet a further objective of this invention is to provide a computer readable medium storing a computer program for a deploying apparatus to execute a method for deploying a network in a space. The method comprises the following steps: generating a plurality of grid points in the space; disposing a first network node having a first effective connection range on one of the grid points, wherein the first effective connection range covers a part of the grid points; marking a part of the grid points covered by the first effective connection range as first grid points; and disposing a second network node having a second effective connection range on one of the first grid points, wherein the second effective connection range covers the first network nodes and a part of the grid points. An effective connection range of the network in the space covers the first effective connection range and the second effective connection range.

Yet a further objective of this invention is to provide a computer readable medium storing a computer program for a deploying apparatus to execute a method for deploying a network in a space. The network has a plurality of network nodes, and each of the network nodes has an effective connection range. The method comprises the following steps: generating a plurality of grid points in the space; marking the grid points covered by the effective connection ranges as the effective grid points; and disposing a first network node having a first effective connection range on one of the effective grid points, wherein the first effective connection range covers one of the network nodes and a part of the grid points. The effective connection range of the network in the space covers the first effective connection range and the effective connection ranges of the network nodes.

The method of this invention is able to segment a space into a plurality of sub-spaces and then decide locations to dispose network nodes for each of the sub-spaces, respectively. Under this condition, when deploying a wireless network, data amount required to be calculated can be reduced greatly so that the deploying time can be reduced and an effective range that the wireless network requires for can be satisfied. More specifically, an awkward situation of recalculating all locations of the network nodes when a part of the space or the amount of the network nodes is changed of the prior art can be solved.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic diagram illustrating a deploying apparatus of a first embodiment of the present invention;

FIG. 2 is a space schematic diagram illustrating the first embodiment of the present invention;

FIG. 3 is a space schematic diagram illustrating the first embodiment comprising a first network node;

FIG. 4 is a space schematic diagram illustrating the first embodiment comprising a second network node;

FIG. 5 is a space schematic diagram illustrating the first embodiment comprising a third network node;

FIG. 6 is another space schematic diagram illustrating the first embodiment comprising a third network node;

FIG. 7 is a space schematic diagram illustrating a second embodiment of the present invention;

FIG. 8 is a flow chart illustrating a third embodiment of the present invention; and

FIG. 9 is a flow chart illustrating a forth embodiment of the present invention.

### DESCRIPTION OF THE PREFERRED EMBODIMENT

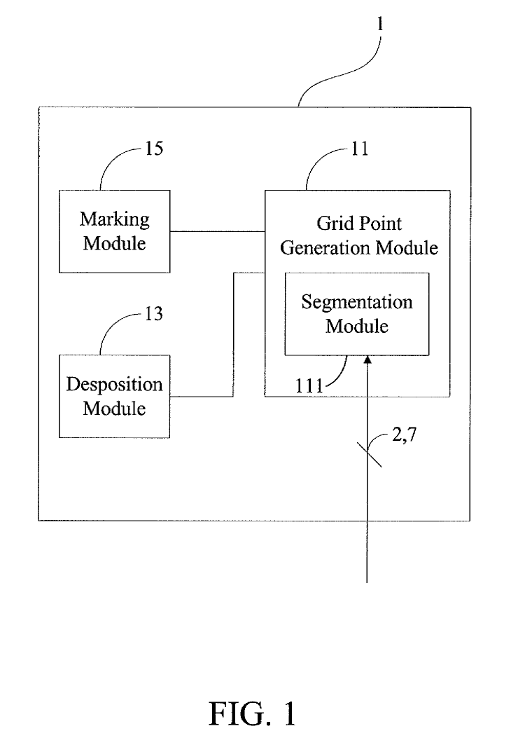

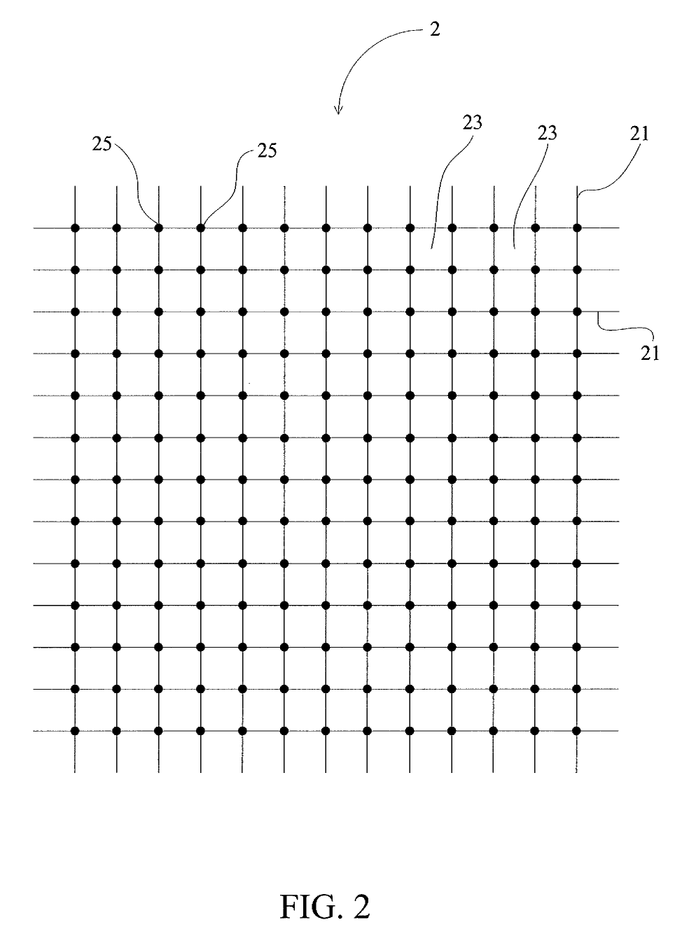

As shown in FIG. 1, a first embodiment of this invention is a deploying apparatus 1 for deploying a network in a space. The network can be a wireless network of various kinds of specifications, such as wireless networks with different standards like IEEE 802.11, IEEE 802.16 or IEEE 802.15.4 (ZigBee), etc. FIG. 2 is a schematic diagram illustrating the space. The deploying apparatus 1 comprises a grid point generation module 11, a disposition module 13, and a marking module 15. The grid point generation module 11 comprises a segmentation module 111.

Before deploying a wireless network, every parameter related to space 2 has already built in the grid point generation module 11. The parameters comprise a size of the space 2, each object and the corresponding material thereof in the space 2, and physical characteristics of a piercing ratio and a reflection ratio of the material corresponding to wireless signals. These parameters are all able to affect an effective range of the wireless network.

At first, the grid point generation module 11 generates a plurality of grid points in the space 2. A specific way is that the segmentation module 111 generates a plurality of grid lines 21 in the space 2 to segment the space 2 into a plurality of subspaces 23. The marking module 15 marks borders between the subspaces 23 as grid points 25, that is, marks connection parts of the grid lines 21 as the grid points 25.

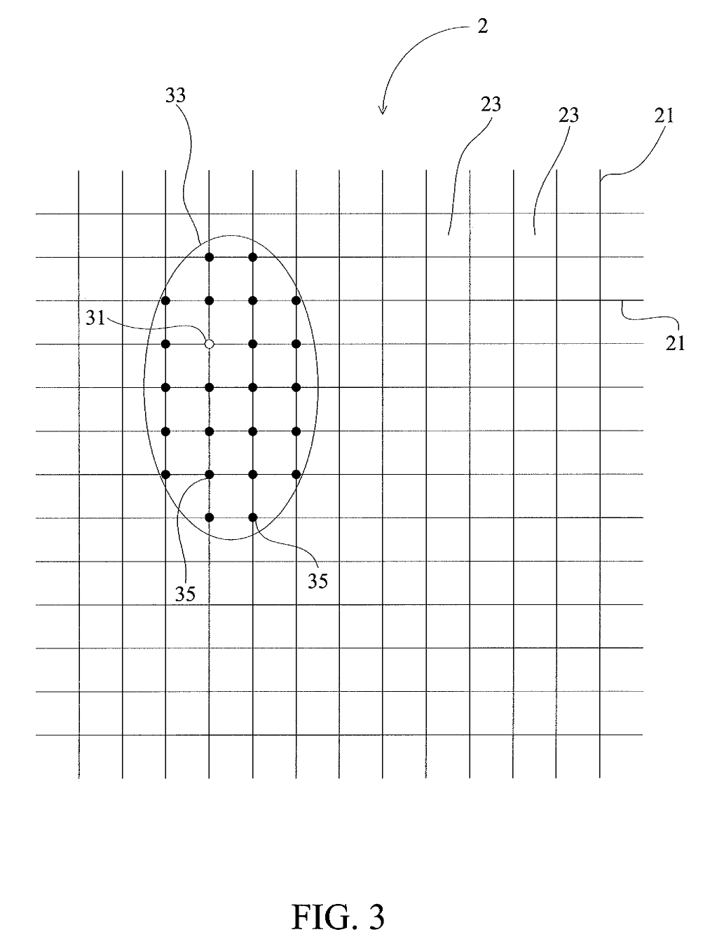

As shown in FIG. 3, the disposition module 13 disposes a first network node 31 on one of the grid points 25, wherein the first network node 31 can either be disposed on a grid point that a user defines, or be disposed on a grid point that is assigned randomly by the disposition module 13. The first network node 31 has a first effective connection range 33 and the first effective connection range 33 covers a part of the grid points 25. The marking module 15 marks the grid points 25 covered by the first effective connection range 33 as the first grid points 35. Need to be noted is that the marking module 15 is not necessary to mark all of the grid points 25 covered by the first effective connection range 33 as the first grid points 35. The marking module 15 can only mark a part of the grid points 25 as the first grid points 35 depending on the actual condition in order to reduce the data amount required calculating. After the first network node 31 is disposed, the effective connection range of the wireless network in the space 2 is only a coverage range of the first effective connection range 33 in the space 2.

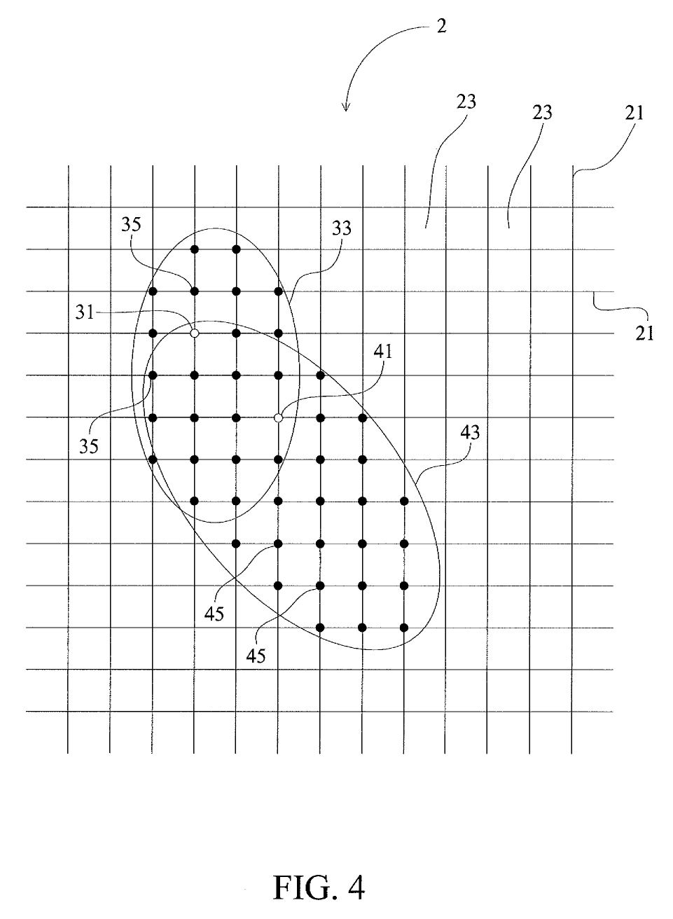

Refer to FIG. 4, the disposition module 13 continuously disposes a second network node 41 on one of the first grid points 35 after the first network node 31 has been disposed. The second network node 41 has a second effective connection range 43 which covers the first network node 31 and a part of the grid points 25. And the reason why the second effective connection range 43 has to cover the first network node 31 is that the second network node 41 and the first network node 31 can transmit data to each other based on this condition. At this moment, the effective connection range of the wireless network in the space 2 is the united coverage range of the first effective connection range 33 and the second effective connection range 43 in the space 2.

The above second network node 41 can be disposed on any of the first grid points 35 marked in the first effective connection range 33. And under a presupposition of the second effective connection range 43 of the second network node 41 is capable of covering the first network node 31, a preferred disposed location of the second network node 41 is the first grid point 35 of the second effective connection range 43 capable of covering the largest amount of the grid points 25, so that the effective connection range of the wireless network will be expand as far as possible.

After the second network node 41 has been disposed, the third network node 51 can be disposed continuously. At this moment, the marking module 15 marks the grid points 25 covered by the second effective connection range 43 as second grid points 45 first. Similarly, not all of the grid points 25 covered by the second effective connection range 43 required to be marked as the second grid points 45. The marking module 15 may mark only a part of the grid points 25 as the second grid points 45 depending on the actual condition in order to reduce the data amount required to be calculated.

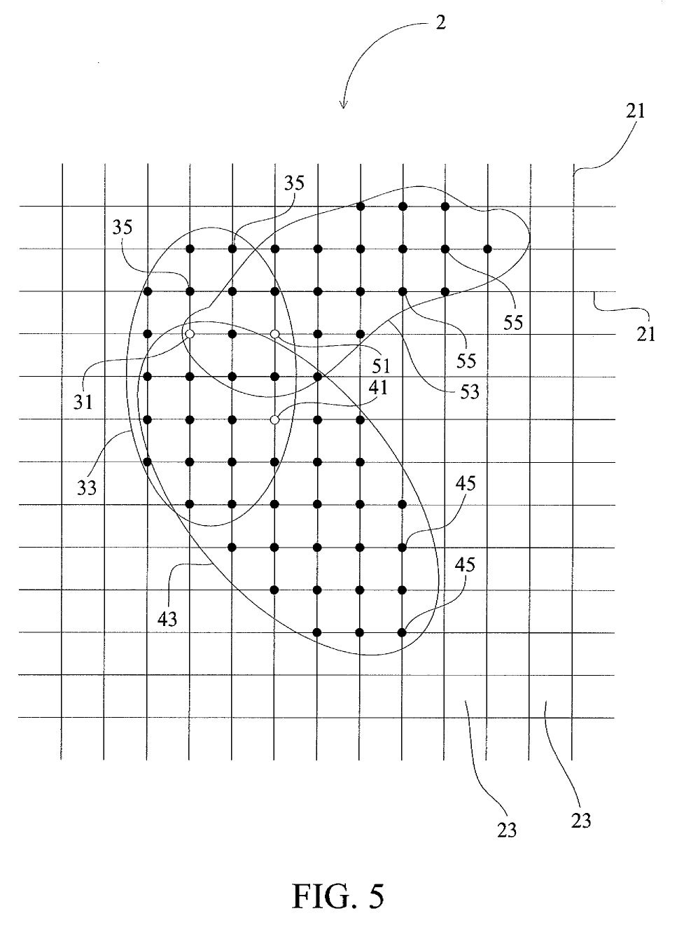

Next, two different situations may occur. The third network node 51 may be disposed on either one of the first grid points 35 or on one of the second grid points 45 to make the deploying of the wireless network more flexible. As shown in FIG. 5, when the disposition module 13 disposes the third network node 51 on one of the first grid points 35, a third effective connection range 53 of the third network node 51 will cover a part of the grid points 25. The third effective connection range 53 has to cover the first network node 31, so that the third network node 51 and the first network node 31 can transmit data to each other. At this moment, the effective connection range of the wireless network in the space 2 is the united coverage range of the first effective connection range 33, the second effective connection range 43, and the third effective connection range 53 in the space 2.

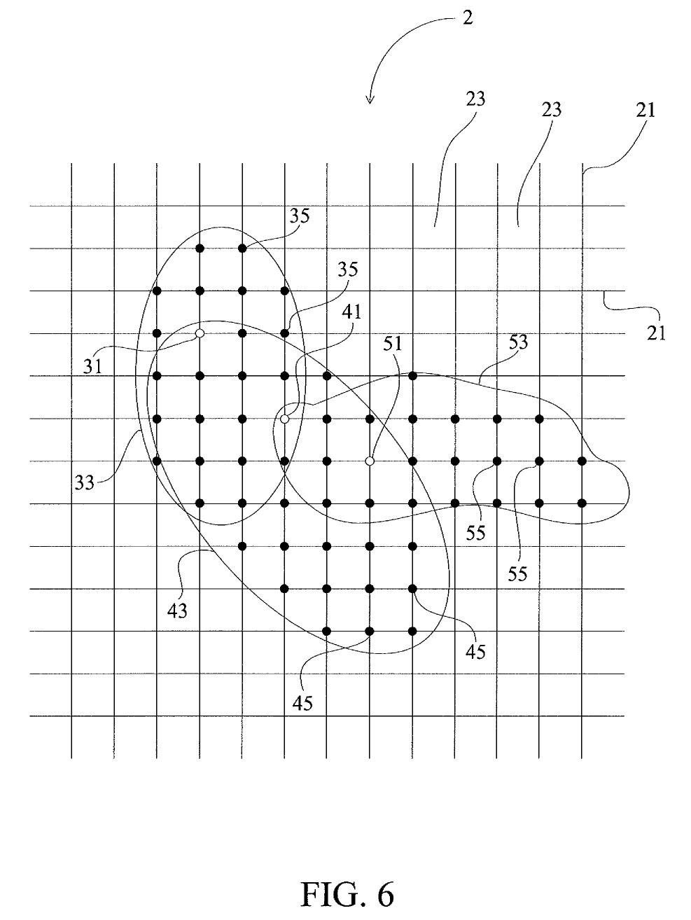

Another situation of disposing the third network node 51 is shown in FIG. 6. When the disposition module 13 disposes the third network node 51 on one of the second grid points 45, a third effective connection range 53 of the third network node 51 will cover a part of the grid points 25. The third effective connection range 53 has to cover the second network node 41 as well, so that the third network node 51 and the second network node 41 can transmit data to each other. At this moment, the effective connection range of the wireless network in the space 2 is the united coverage range of the first effective connection range 33, the second effective connection range 43, and the third effective connection range 53 in the space 2.

According to the above descriptions, the third network node 51 can be disposed on any of the first grid points 35 marked in the first effective connection range 33 or any of the second grid points 45 marked in the second effective connection range 43. When the third network node 51 is disposed on one of the first grid points 35, under a presupposition of the third effective connection range 53 of the third network node 51 is capable of covering the first network node 31, a preferred disposed place of the third network node 51 is the first grid points 35 of the third effective connection range 53 capable of covering the largest amount of the grid points 25. Furthermore, when the third network node 51 is disposed on one of the second grid points 45, under a presupposition of the third effective connection range 53 of the third network node 51 is capable of covering the second network node 41, a preferred disposed place of the third network node 51 is the second grid points 45 of the third effective connection range 53 capable of covering the largest amount of the grid points 25. By the above disposing method, the deploying apparatus 1 can expand the effective connection range of the wireless network in the best efficiency.

After the third network node 51 is disposed, the following network nodes can also be disposed by the same method as mentioned in the previous paragraphs. For example, when a forth network node is be disposed, the marking module 15 marks the grid points 25 covered by the third effective connection range 53 as the third grid points 55. Similar with the mentioned paragraphs, not all of the grid points 25 covered by the third effective connection range 53 need to be marked as the third grid points 55. The marking module 15 can mark a part of the grid points 25 as the third grid points 55 depending on the actual condition in order to reduce the data amount required calculating. Next, the disposition module 13 can dispose the forth network node on one of the first grid points 35, one of the second grid points 45, or one of the third grid points 55 to achieve the objective of disposing other network nodes. Those skilled in this field can straightforwardly realize the corresponding operations of disposing other network nodes based on the above descriptions, and thus no unnecessary detail is given here.

The effective connection range of the mentioned network nodes in the first embodiment is a radiation pattern of a 3D radio frequency (RF) signal thereof. For example, the first effective connection range 33 is a radiation pattern of a 3D RF signal of the first network nodes 31, the second effective connection range 43 is a radiation pattern of a 3D RF signal of the second network nodes 41, and the third effective connection range 53 is a radiation pattern of a 3D RF signal of the third network nodes 51. These radiation patterns of 3D RF signals will be affected by factors of materials and manufacture processes when the network nodes are manufactured. Therefore, different network nodes will have different radiation patterns of 3D RF signals.

With the above configurations, this embodiment can rapidly deploy the network in the space according to the precise locations and the radiation patterns of the network nodes.

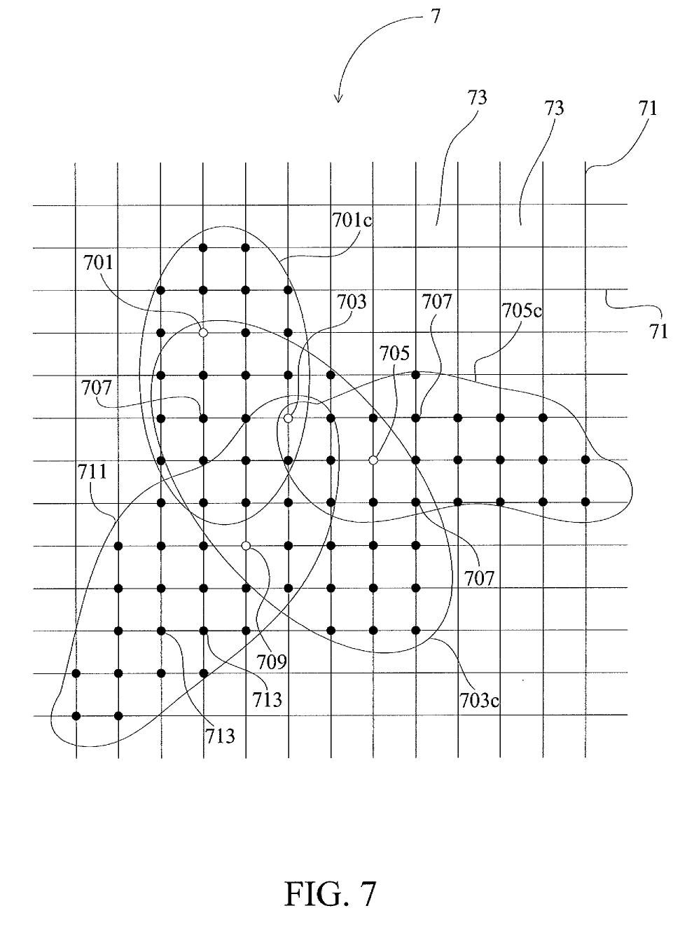

A second embodiment of this invention is a deploying apparatus 1 capable of deploying a network in a space. The deploying apparatus 1 described in the second embodiment is the same as the one described in the first embodiment, which comprises a grid point generation module 11, a disposition module 13, and a marking module 15. The grid point generation module 11 further comprises a segmentation module 111. This network can also be a wireless network with various standards, such as wireless networks with different standards like IEEE 802.11, IEEE 802.16, or IEEE 802.15.4 (ZigBee). As shown in FIG. 7, the network of the second embodiment has already disposed a plurality of network nodes 701, 703, 705 with effective connection ranges 701c, 703c, 705c, respectively.

While intending to add a network node in these network nodes 701, 703, and 705, every parameter related to a space 7 is already built in the grid point generation module 11. The parameters comprise a size of the space 7, each object and corresponding material thereof in the space 7, and physical characteristics of a piercing ratio and a reflection ratio of the material corresponding to wireless signals. These parameters are all able to affect an effective range of the wireless network.

At first, the grid point generation module 11 generates a plurality of grid points in the space 7. A specific way is that the segmentation module 111 generates a plurality of grid lines 71 in the space 7 to segment the space 7 into a plurality of subspaces 73. The marking module 15 marks borders between the subspaces 73 as grid points, that is, marks connection parts of the grid lines 71 as grid points. The marking module 15 marks these grid points covered by the effective connection range 701c, 703c, 705c as effective grid points 707. When intending to add a new network node, the disposition module 13 will dispose a first network node 709 on one of the effective grid points 707, wherein a first effective connection range 711 of the first network node 709 will cover a part of the grid points. At the same time, the first effective connection range 711 must cover one of the network nodes 701, 703, 705. As shown in FIG. 7, the first effective connection range 711 of the first network node 709 of this embodiment covers the network node 703, so that the network node (i.e. the network node 703) covered by the first effective connection range 711 and the first network node 709 can transmit data to each other. At this moment, the effective connection range of the wireless network in the space 7 is a united coverage range of the first effective connection range 711 and the effective connection range 701c, 703c, 705c covered in the space 7. If intending to continuously dispose other network nodes, the marking module 15 will mark the grid point covered by the first effective connection range 711 as the first grid point 713. Not all of the grid points covered by the first effective connection range 711 need to be marked as the first grid point 713. The marking module 15 can mark a part of the grid points as the first grid point 713 depending on the actual condition in order to reduce a data amount required calculating. The rest network nodes are continuously deployed by the above method.

Those skilled in this field can understand that the radiation patterns of 3D RF signals of network nodes 701, 703, 705, 709 of the second embodiment correspond to the effective connection ranges 701c, 703c, 705c, and the first effective connection range 711 thereof by the above descriptions of the first embodiment, and thus no unnecessary detail is given here.

With the above configuration, this embodiment can rapidly deploy the network in the space according to the precise locations and the radiation patterns of the network nodes.

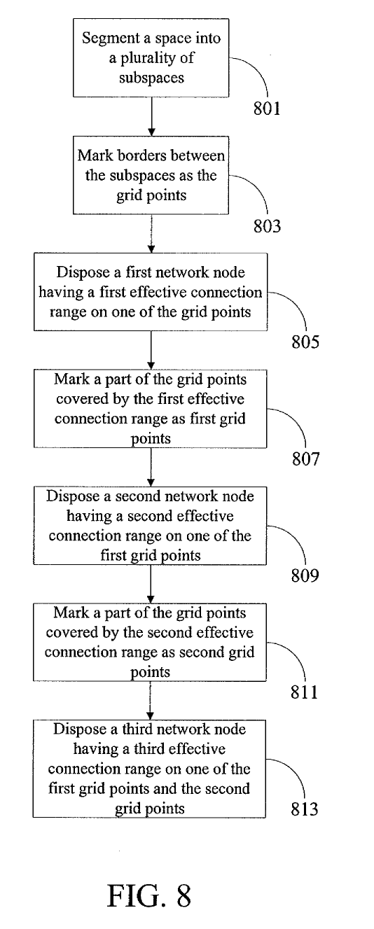

A third embodiment of the present invention is a method for deploying a network in a space. This method is applied to the deploying apparatus 1 described in the first embodiment. As shown in FIG. 8, the method of the third embodiment is performed by a computer program which is stored in a computer readable medium.

At first, step 801 is executed, in which the computer program comprises code for the segmentation module 111 to segment the space into a plurality of subspaces. Then, step 803 is executed, in which the computer program comprises code for the marking module 15 to mark borders of the subspaces as the grid points. In other words, according to step 801 and step 803, the computer program comprises code for the grid point generation module 11 to generate a plurality of grid points in the space. Next, step 805 is executed, in which the computer program comprises code for the disposition module 13 to dispose a first network node having a first effective connection range on one of the grid points, wherein the first effective connection range covers a part of the grid points. After step 805 is executed, an effective connection range of the network in the space is a coverage range of the first effective connection range.

Next, step 807 is executed, in which the computer program comprises code for the marking module 15 to mark the grid points covered by the first effective connection range as the first grid points. Then, step 809 is executed, in which the computer program comprises code for the disposition module 13 to dispose a second network node having a second effective connection range on one of the first grid points, wherein the second effective connection range covers the first network node and a part of the grid points. After step 809 is executed, an effective connection range of the network in the space is the coverage range of the first effective connection range and the second effective connection range.

Later, step 811 is executed, in which the computer program comprises code for the marking module 15 to mark the grid points covered by the second effective connection range as the second grid points. Finally, step 813 is executed, in which the computer program comprises code for the disposition module 13 to dispose a third network node having a third effective connection range on one of the first grid points and the second grid points. At the time, the third effective connection range further comprises one of the first network node and the second network node or their combination. After step 813 is executed, an effective range of the network in the space is the united coverage range of the first effective connection range, the second effective connection range, and the third effective connection range.

In addition to the steps shown in FIG. 8, the computer program of third embodiment has code able to execute all of the operations or functions recited in the first embodiment. Those skilled in this field can straightforwardly realize how the third embodiment performs these operations and functions based on the above descriptions of the first embodiment, and thus no unnecessary detail is given here.

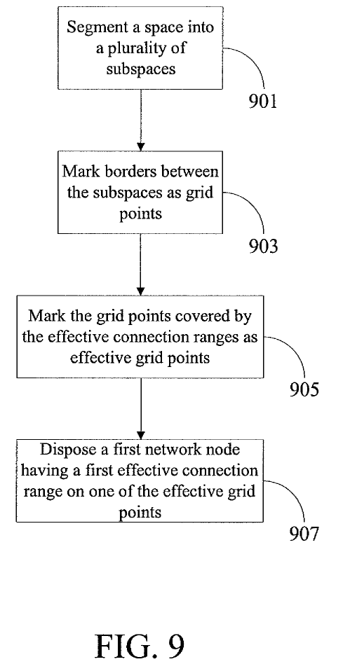

A fourth embodiment of this invention is a method for deploying a network in a space. This method is applied to the deploying apparatus 1 described in the second embodiment. As shown in FIG. 9, the method of the fourth embodiment is performed by a computer program which is stored in a computer readable medium. The network has already disposed a plurality of network nodes, and each of the network nodes has an effective connection range.

At first, step 901 is executed, in which the computer program comprises code for the segmentation module to segment the space into a plurality of subspaces. Then, step 903 is executed, in which the computer program comprises code for the marking module to mark borders of the subspaces as grid points. In other words, according to step 901 and step 903, the computer program comprises code for the grid point generation module 11 to generate a plurality of grid points in the space. Next, step 905 is executed, in which the computer program comprises code for the marking module 15 to mark the grid points covered by the effective connection range as the effective grid points. Step 907 is executed, in which the computer program comprises code for the disposition module 13 to dispose a first network node having a first effective connection range on one of the grid points, wherein the first effective connection range covers a part of the grid points. At this moment, the effective connection range of the network in the space is the coverage range of the first effective connection range.

In addition to the steps shown in FIG. 9, the computer program of fourth embodiment has code able to execute all of the operations or functions recited in the second embodiment. Those skilled in this field can straightforwardly realize how the fourth embodiment performs these operations and functions based on the above descriptions of the second embodiment, and thus no unnecessary detail is given here.

A fifth embodiment of this invention is a method for deploying a network in a space. This method is applied to the deploying apparatus 1 described in the first embodiment. For a more detailed description, the method of the fifth embodiment is the same as the method of the third embodiment.

At first, step 801 is executed for segmenting the space into a plurality of subspaces. Then, step 803 is executed for marking borders of the subspaces as grid points. In other words, according to step 801 and step 803, the method generates a plurality of grid points in the space. Next, step 805 is executed for disposing a first network node having a first effective connection range on one of the grid points, wherein the first effective connection range covers a part of the grid points. After step 805 is executed, an effective range of the network in the space is a coverage range of the first effective connection range.

Next, step 807 is executed for marking the grid points covered by the first effective connection range as the first grid points. Then, step 809 is executed for disposing a second network node having a second effective connection ranges on one of the first grid points, wherein the second effective connection range covers the first network node and a part of the grid points. After step 809 is executed, an effective range of the network in the space is the coverage range of the first effective connection range and the second effective connection range.

Next, step 811 is executed for marking the grid points covered by the second effective connection range as the second grid points. Finally, step 813 is executed for disposing a third network node having a third effective connection range on one of the first grid points and the second grid points. At this moment, the third effective connection range further comprises one of the first network node and the second network node or their combination. After step 813 is executed, an effective range of the network in the space is the coverage range of the first effective connection range, the second effective connection range, and the third effective connection range.

In addition to the steps shown in FIG. 8, the method of fifth embodiment is able to execute all of the operations or functions recited in the first embodiment. Those skilled in this field can straightforwardly realize how the fifth embodiment performs these operations and functions based on the above descriptions of the first embodiment, and thus no unnecessary detail is given here.

A sixth embodiment of this invention is a method for deploying a network in a space. This method is applied to the deploying apparatus 1 described in the second embodiment. For a more detailed description, the method of the forth embodiment is the same as the method of the sixth embodiment.

At first, step 901 is executed for segmenting the space into a plurality of subspaces. Later, step 903 is executed for marking the borders of the subspaces as grid points. In other words, according to step 901 and step 903, the method generates a plurality of grid points in the space. Next, step 905 is executed for marking the grid points covered by the effective connection range as the effective grid points. Finally, step 907 is executed for disposing a first network node having a first effective connection range on one of the grid points, wherein the first effective connection range covers a part of the grid points. At this moment, the effective range of the network in the space is the coverage range of the first effective connection range.

In addition to the steps shown in FIG. 9, the method of sixth embodiment is able to execute all of the operations or functions recited in the second embodiment. Those skilled in this field can straightforwardly realize how the sixth embodiment performs these operations and functions based on the above descriptions of the second embodiment, and thus no unnecessary detail is given here.

The computer program may be stored in a computer readable medium. The computer readable medium can be a floppy disk, a hard disk, an optical disc, a flash disk, a tape, a database accessible from a network, or a storage medium with the same functionality that can be easily thought by people skilled in the art.

Accordingly, the present invention deploys a wireless network by segmenting a space into several sub-spaces first and then determining the locations to dispose the network nodes for each of the segmented space respectively. Besides, the present invention can only re-dispose network nodes in a changed portion of the space, when the size of the space or the amount of network nodes in the space changes. With this way, drawbacks of a large amount of data calculation and recalculation of disposing locations for all network nodes when a size of the space is changed partially or the amount of network nodes is changed of the prior art can be successfully concurred.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A method for deploying a network in a space, comprising the steps of:
generating a plurality of grid points in the space;
disposing a first network node having a first effective connection range on one of the grid points, wherein the first effective connection range covers a part of the grid points;
marking a part of the grid points covered by the first effective connection range as first grid points; and
disposing a second network node having a second effective connection range on one of the first grid points, wherein the second effective connection range covers the first network node and a part of the grid points;
wherein an effective connection range of the network in the space covers the first effective connection range and the second effective connection range.

2. The method of claim 1, wherein the generating step comprises the steps of:
segmenting the space into a plurality of subspaces; and
marking borders between the subspaces as the grid points.

3. The method of claim 1, wherein the first grid point disposed the second network node makes the second effective connection range cover the greatest amount of the grid points.

4. The method of claim 1, wherein the first effective connection range is a radiation pattern of a 3 Dimensions (3D) radio frequency (RF) signal of the first network node, and the second effective connection range is a radiation pattern of a 3D RF signal of the second network node.

5. The method of claim 1, further comprising the steps of:
marking a part of the grid points covered by the second effective connection range as second grid points; and
disposing a third network node having a third effective connection range on one of the first grid points and the second grid points, wherein the third effective connection range covers a part of the grid points;
wherein the effective connection range of the network in the space covers the first effective connection range, the second effective connection range, and the third effective connection range.

6. The method of claim 5, wherein when the third network node is disposed on one of the first grid points, the third effective connection range covers the first network node.

7. The method of claim 6, wherein the first grid point disposed the third network node makes the third effective connection range cover the greatest amount of the grid points.

8. The method of claim 5, wherein when the third network node is disposed on one of the second grid points, the third effective connection range covers the second network node.

9. The method of claim 8, wherein the second grid point disposed the third network node makes the third effective connection range cover the biggest amount of the grid points.

10. The method of claim 5, wherein the third effective connection range is a radiation pattern of a 3D RF signal of the third network node.

11. A method for deploying a network in a space, the network having a plurality of network nodes, each of the network nodes having an effective connection range, the method comprising the steps of:
generating a plurality of grid points in the space;
marking the grid points covered by the effective connection ranges as effective grid points; and
disposing a first network node having a first effective connection range on one of the effective grid points, wherein the first effective connection range covers one of the network nodes and a part of the grid points;
wherein the effective connection range of the network in the space covers the first effective connection range and the effective connection ranges of the network nodes.

12. The method of claim 11, wherein the generating step comprises the steps of:
segmenting the space into a plurality of subspaces; and
marking borders between the subspaces as the grid points.

13. The method of claim 11, wherein each of the effective connection ranges is a radiation pattern of a 3D RF signal of the corresponding network node and the first effective connection range is a radiation pattern of a 3D RF signal of the first network node.

14. A deploying apparatus capable of deploying a network in a space, comprising:
a grid point generation module for generating a plurality of grid points in the space;
a disposition module for disposing a first network node having a first effective connection range on one of the grid points, wherein the first effective connection range covers a part of the grid point; and
a marking module for marking a part of the grid points covered by the first effective connection range as first grid points;
wherein the disposition module further disposes a second network node having a second effective connection range on one of the first grid points, the second effective connection range covers the first network node and a part of the grid points, and an effective connection range of the network in the space covers the first effective connection range and the second effective connection range.

15. The deploying apparatus of claim 14, wherein the grid point generation module comprises a segmentation module for segmenting the space into a plurality of subspaces and the marking module further marks borders between the subspaces as the grid points.

16. The deploying apparatus of claim 14, wherein the first grid point disposed the second network node makes the second effective connection range cover the biggest amount of the grid points.

17. The deploying apparatus of claim 14, wherein the first effective connection range is a radiation pattern of a 3D RF signal of the first network node and the second effective connection range is a radiation pattern of a 3D RF signal of the second network node.

18. The deploying apparatus of claim 14, wherein the marking module further marks a part of the grid points covered by the second effective connection range as second grid points, the disposition module further disposes a third network node having a third effective connection range on one of the first grid points and the second grid points, the third effective connection range covers a part of the grid points, and the effective connection range of the network in the space covers the first effective connection range, the second effective connection range, and the third effective connection range.

19. The deploying apparatus of claim 18, wherein when the disposition module disposes the third network node on one of the first grid points, the third effective connection range covers the first network node.

20. The deploying apparatus of claim 19, wherein the first grid point disposed the third network node makes the third effective connection range cover the greatest amount of the grid points.

21. The deploying apparatus of claim 18, wherein when the disposition module disposes the third network node on one of the second grid points, the third effective connection range covers the second network node.

22. The deploying apparatus of claim 21, wherein the second grid point disposed the third network node makes the third effective connection range cover the greatest amount of the grid points.

23. The deploying apparatus of claim 18, wherein the third effective connection range is a radiation pattern of a 3D RF signal of the third network node.

24. A deploying apparatus capable of deploying a network in a space, the network having a plurality of network nodes, each of the network nodes having an effective connection range, the deploying apparatus comprising:
a grid point generation module for generating a plurality of grid points in the space;
a marking module for marking the grid points covered by the effective connection ranges as effective grid points
a disposition module for disposing a first network node having a first effective connection range on one of the effective grid points, wherein the first effective connection range covers one of the network nodes and a part of the grid points;
wherein the effective connection range of the network in the space covers the first effective connection range and the effective connection ranges of the network nodes.

25. The deploying apparatus of claim 24, wherein the grid point generation module comprises a segmentation module for segmenting the space into a plurality of subspaces and the marking module further marks borders between the subspaces as the grid points.

26. The deploying apparatus of claim 24, wherein each of the effective connection ranges is a radiation pattern of a 3D RF signal of the corresponding network node and the first effective connection range is a radiation pattern of a 3D RF signal of the first network node.

27. A computer readable medium storing a computer program for a deploying apparatus to execute a method for deploying a network in a space, the method comprising the steps of:
generating a plurality of grid points in the space;
disposing a first network node having a first effective connection range on one of the grid points, wherein the first effective connection range covers a part of the grid points;
marking a part of the grid points covered by the first effective connection range as first grid points; and
disposing a second network node having a second effective connection range on one of the first grid points, wherein the second effective connection range covers the first network node and a part of the grid points;
wherein an effective connection range of the network in the space covers the first effective connection range and the second effective connection range.

28. The computer readable medium of claim 27, wherein the generating step comprises the steps of:
segmenting the space into a plurality of subspaces; and
marking borders between the subspaces as the grid points.

29. The computer readable medium of claim 27, wherein the first grid point disposed the second network node makes the second effective connection range cover the greatest amount of the grid points.

30. The computer readable medium of claim 27, wherein the first effective connection range is a radiation pattern of a 3D RF signal of the first network node and the second effective connection range is a radiation pattern of a 3D RF signal of the second network node.

31. The computer readable medium of claim 27, further comprising the steps of:
marking a part of the grid points covered by the second effective connection range as second grid points; and
disposing a third network node having a third effective connection range on one of the first grid points and the second grid points, wherein the third effective connection range covers a part of the grid points;
wherein the effective connection range of the network in the space covers the first effective connection range, the second effective connection range, and the third effective connection range.

32. The computer readable medium of claim 31, wherein when the third network node is disposed on one of the first grid points, the third effective connection range covers the first network node.

33. The computer readable medium of claim 32, wherein the first grid point disposed the third network node makes the third effective connection range cover the biggest amount of the grid points.

34. The computer readable medium of claim 31, wherein when the third network node is disposed on one of the second grid points, the third effective connection range covers the second network node.

35. The computer readable medium of claim 34, wherein the second grid point disposed the third network node makes the third effective connection range cover the biggest amount of the grid points.

36. The computer readable medium of claim 31, wherein the third effective connection range is a radiation pattern of a 3D RF signal pattern of the third network node.

37. A computer readable medium storing a computer program for a deploying apparatus to execute a method for deploying a network in a space, the network having a plurality of network nodes, each of the network nodes having an effective connection range, the method comprising the steps of:
generating a plurality of grid points in the space;
marking the grid points covered by the effective connection ranges as effective grid points; and
disposing a first network node having a first effective connection range on one of the effective grid points, wherein the first effective connection range covers one of the network nodes and a part of the grid points;
wherein the effective connection range of the network in the space covers the first effective connection range and the effective connection ranges of the network nodes.

38. The computer readable medium of claim 37, wherein the generating step comprises the steps of:
segmenting the space into a plurality of subspaces; and
marking borders between the subspaces as the grid points.

39. The computer readable medium of claim 37, wherein each of the effective connection ranges is a radiation pattern of a 3D RF signal of the corresponding network node and the first effective connection range is a radiation pattern of a 3D RF signal of the first network node.
